(19) United States
(12) Patent Application Publication
(10) Pub. No.: US 2004/0127091 A1
(43) Pub. Date: Jul. 1, 2004

(54) Electrical cable assembly

(76) Inventors: Takaki Naito, Kawasaki-shi (JP); Doron Lapidot, Tokyo (JP); Masayuki Aizawa, Tokyo (JP)

Correspondence Address: JoAnn Dilloway, Barley, Snyder,, 126 East King Street, Lancaster, PA, 17602-2893, US

(21) Appl. No.: 10/735,115

(22) Filed: Dec. 12, 2003

(30) Foreign Application Priority Data
Dec. 27, 2002 (JP) 2002-379803

(51) Int. Cl. H01R 3/00

(52) U.S. Cl. 439/488

(57) ABSTRACT

The present invention aims to provide an electrical cable assembly which is inexpensive and allows a user to make a proper connection between devices. Electrical connectors which are fixed on both ends of the cable are provided with a visual indicator which enables a user to make a proper connection with a tuner or PDP (Plasma Display Panel) even with the interchangeable mating surfaces of the electrical connectors.

### FIELD OF THE INVENTION

The present invention relates to an electrical cable assembly having a cable with electrical connectors fixed on both ends of the cable wherein the connectors include electrical contacts and a housing storing the electrical contacts, and the housings have interchangeable mating surfaces.

### BACKGROUND OF THE INVENTION

In recent years, liquid crystal display (LCD) panels have become widely accepted as display panels for use with personal computers (PCs), and other applications. An LCD differs from a CRT (cathode-ray tube) monitor, which receives an analog signal from the main unit of a PC and performs processing according to the analog signal. In an LCD panel, even a digital signal can be supplied from the main unit of a PC to the LCD panel, and processing can be accomplished according to the digital signal. In anticipation of liquid crystal display panels becoming predominant as display panels used for PCs in the future, a standard criterion on connection between a PC and a liquid crystal display panel is defined. The criterion is called DVI (Digital Visual Interface) standard, which is proposed by an organization called the DDWG (Digital Display Working Group).

FIG. 1 is a diagram showing a mating surface of an electrical connector which is compliant with the DVI standard. FIG. 1 shows the mating surface of a plug type electrical connector 1 provided on the cable assembly side.

As shown in FIG. 1, electrical contacts 2 are regularly arranged in three rows on the mating surface. A contact 3 for grounding is additionally provided beside the electrical contacts 2 arranged in three rows. The contact 3 mates with the contact of a mating electrical connector of a receptacle type. When all the electrical contacts arranged in three rows are mated, electrical conduction is produced. The plug-type electrical connectors 1 having such mating surfaces 4 are fixed on both ends of a cable. One of the fixed electrical connectors is mated to a receptacle-type electrical connector on the main unit of a PC, the other is mated to a receptacle-type electrical connector on a liquid crystal display panel, and thus the PC and the liquid crystal display panel are electrically connected to each other.

In the DVI standard, a technique of transmitting a differential signal is used to improve the quality of a transmitted signal when communications are carried out between a PC and a liquid crystal display panel. The electrical contacts 2 in the housing that form the mating surface 4 of FIG. 1 are paired and transmit a single differential signal. Thus, a large number of electrical contacts 2 are provided. Further, even the use of a differential signal may cause noise in a transmission path and a dot error or a pixel error in an image displayed on a liquid crystal display panel. In U.S. Pat. No. 5,766,027, an equalizer circuit disposed in an electrical connector is proposed to remove the influence of the jitter.

In recent years liquid crystal display panels have also been frequently used with television receivers. The television receivers are used to transfer image data having been received by a tuner to a display and provide a display of an image according to the image data. Further, plasma display panels (hereinafter, referred to as PDPs) have become available for in-home use as a substitute for liquid crystal display panels. In many cases these liquid crystal display panels and panel-type display panels such as a PDP have a tuner or a set top box (hereinafter, referred to as a “host side”) which is disposed separately from the display. A high-quality image can be expected by using the cable assembly to connect the host side and the plasma display.

However, the cable assembly described in U.S. Pat. No. 5,766,027 is premised on communications between a computer such as a server and a storage device. Thus, an equalizer is provided in each electrical connector. In the case of unilateral transmission from the host side to the PDP, however, one of the electrical connectors does not require an equalizer. Hence, the cable assembly of U.S. Pat. No. 5,766,027 provides of an unnecessary equalizer on one of the connectors, which may cause a malfunction. Additionally, when an equalizer is provided even though the equalizer is not necessary, the assembly may become expensive. For this reason, there is a move to define a standard on connection between a PDP and a host side in addition to the DVI standard. The standard is called HDMI (High Definition Multimedia Interface) standard, which additionally defines connection between a host side and a PDP based on the DVI standard.

FIG. 2 is a diagram showing the mating surface of a receptacle-type electrical connector. FIG. 3 is a diagram showing the mating surface of a plug-type electrical connector. As shown in FIGS. 2 and 3, approximately 19 electrical contacts are provided in this example. FIGS. 2 and 3 show electrical contacts No. 1, No. 2, No. 18, and No. 19 disposed on ends. When the receptacle-type electrical connector of FIG. 2 and the plug-type electrical connector of FIG. 3 are mated to each other via the mating surfaces, the corresponding contacts come into contact with each other and produce electrical conduction. In these electrical connectors, a signal transmitted in response to a differential signal is handled by two electrical contacts. A single image signal is transmitted by the two electrical contacts as the DVI standard.

For connecting a PDP with a host, plug-type connectors are conventionally used as electrical connectors fixed on both ends of a cable assembly and receptacle-type connectors are provided on a PDP and a host side. Hence, the electrical connectors fixed on both ends of the cable assembly are plug-type connectors with similar mating surfaces. Thus, an ordinary user may mistakenly connect the electrical connector having the equalizer to a tuner. Such incorrect connection made by an ordinary user interferes with the functions of the equalizer to be operated on the PDP, frequently causing noise on an image of the PDP.

### SUMMARY OF THE INVENTION

The present invention has been made in view of the above circumstances and provides an electrical cable assembly which is inexpensive and prevents the user from making an improper connection between devices.

An electrical cable assembly attaining the above object according to the present invention has a cable, electrical connectors which are fixed on both ends of the cable and include electrical contacts and a housings storing the electrical contacts, the housings having interchangeable mating surfaces. Only one of the electrical connectors has an equalizer circuit, and at least one of the electrical connectors has a visual indicator different from that of the other electrical connector.

According to the electrical cable assembly of the present invention, a connected side is specified by the visual indicator, thereby preventing the user from making incorrect connection. When the present invention is applied to the cable assembly connecting a PDP and a tuner, one of the electrical connectors that is connected to the PDP is visually recognized due to the visual indicator, preventing the user from making incorrect connection. The visual indicator includes, for example, a method of differentiating with the sizes between one electrical connector and the other electrical connector. In this case, the visual indicator can be provided by changing the size of the cover housing of the other electrical connector. Thus, both of the electrical connectors have visual indicators, permitting the user to visually recognize the size difference as the visual indicator and correctly make connection. The visual indicator only based on the size of the cover housing does not require additional members for preventing an incorrect recognition, reducing the cost.

Further, when the visual indicator is a color of the cover housing storing the electrical connector and the equalizer circuit, the effect is enhanced. With the visual indicator of a different color of the cover housing, considering that the user always visually recognizes the cover housing when connecting the cable assembly to the PDP and the tuner, the different color of the cover housing permits the user to confirm whether the cable assembly should be connected to the PDP or the tuner when making connection. Thus, there is a quite high probability that incorrect connection is prevented.

As described above, the cable assembly of the present invention makes it possible to provide a cable assembly which is inexpensive, is compliant with standards such as DVI and HDMI, and allows the user to readily connect the tuner and the PDP.

### BRIEF DESCRIPTION OF THE DRAWINGS

Preferred embodiments of the present invention will be described in detail based on the following figures, wherein:

FIG. 1 is a diagram showing a mating surface of an electrical connector (plug type) which is compliant with DVI standard;

FIG. 2 is a diagram showing a mating surface of an electrical connector (receptacle type) which is compliant with HDMI standard;

FIG. 3 is a diagram showing a mating surface of an electrical connector (plug type) which is compliant with HDMI standard;

FIG. 4 is an exploded view showing an appearance of a cable assembly according to an embodiment of the present invention;

FIG. 5 is an exploded view showing, of the two electrical connectors shown in FIG. 1, the configuration of the electrical connector having an equalizer;

FIG. 6 is a diagram showing an appearance that a housing 12b is inserted into shells and is held by a front shell 12a and a back shell 12c; and

FIG. 7 is a diagram showing the arrangement of an electrical contact 121b and an equalizer substrate 14.

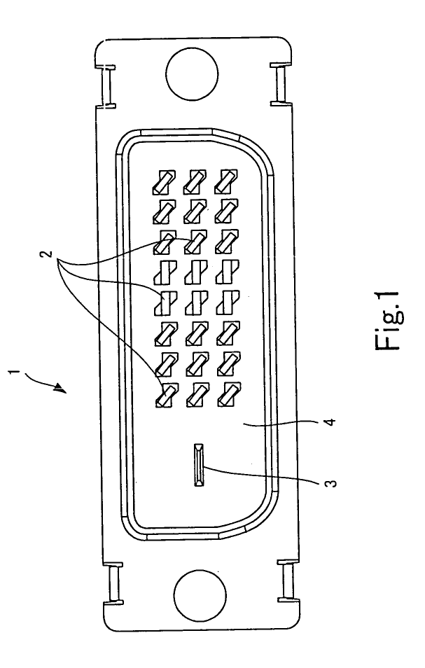

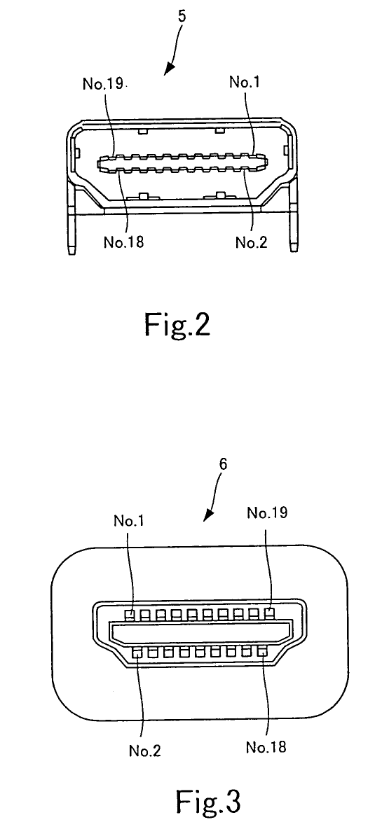

### DETAILED DESCRIPTION OF THE INVENTION

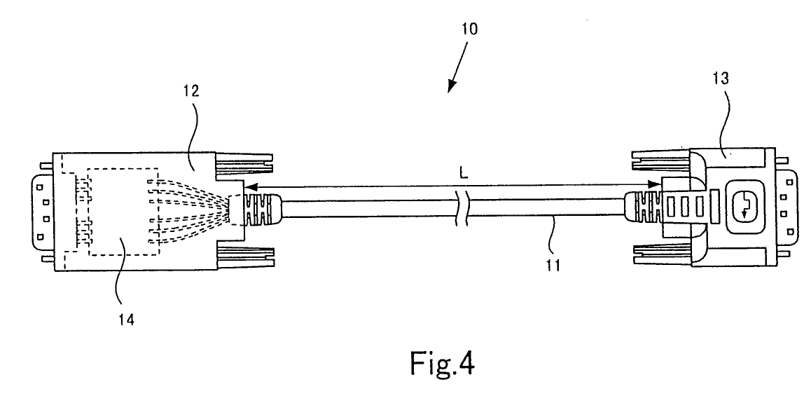

The following will describe a cable according to an exemplary embodiment of the present invention, as shown in FIGS. 4-7.

The configuration of the cable assembly will be described with reference to an example in which a cable assembly compliant with the DVI standard is improved so as to have an electrical connector with an equalizer circuit on one side. The cable compliant with the DVI standard can be readily changed to an improved cable assembly compliant with HDMI standard. As an example of the same configuration, the configuration of the cable assembly will be described with reference to an improved example compliant with the DVI standard.

As shown in FIG. 4, a cable assembly 10 comprises a cable 11 having electrical connectors 12 and 13 fixed on both ends of the cable 11.

The electrical connector 12 fixed on one side has an equalizer substrate 14. The electrical connector on the other side does not have an equalizer substrate 14. A length L of the cable 11 is limited but can be set arbitrarily as long as a waveform is ensured by waveform equalization. The electrical connector 12 on one side is larger in size than the electrical connector 13 on the other side because of the provision of the equalizer substrate 14. Such a difference in size functions as a visual indicator. In FIG. 4, the larger electrical connector 12 is connected to a PDP and the smaller electrical connector 13 is connected to a tuner. Further, if the electrical connector on one side is marked with “PDP” and the electrical connector on the other side with “Tuner”, the effect of the visual indicator is further enhanced. Thus, even an ordinary home user can correctly connect the tuner and the PDP.

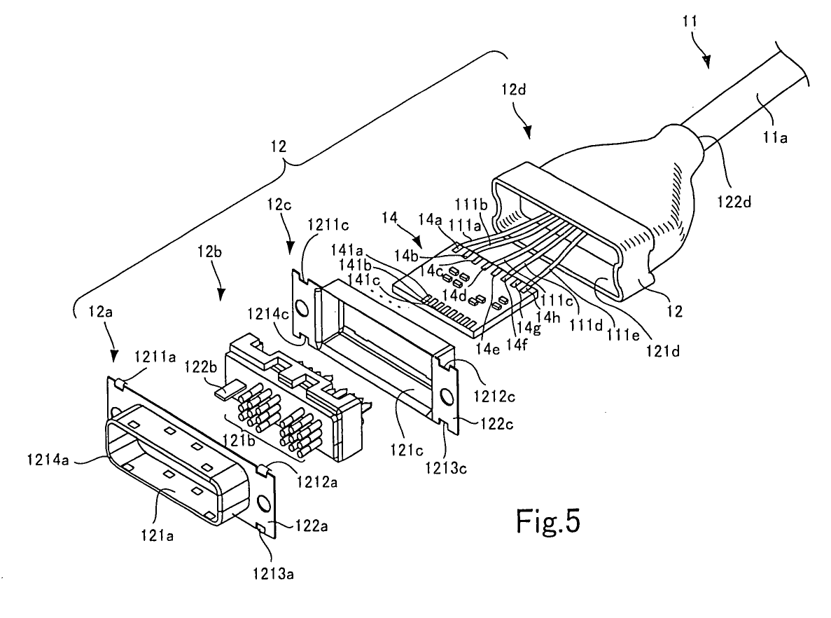

FIG. 5 is an exploded view of the connector 12 of the exemplary cable assembly, having the equalizer substrate 14. As shown in FIG. 5, the electrical connector 12 is constituted of a front shell 12a, a housing 12b supporting electrical contacts 121b, a back shell 12c, the equalizer substrate 14, the cable 11, and a cover housing 12d storing the members. The electrical contacts 121b supported by the housing 12b penetrate the housing 12b and extend in a longitudinal direction.

The cover housing 12d is hollowed with a large opening 121d on one end to receive the back shell 12c and an opening 122d smaller than the large opening 121d on the opposite end to receive the cable 11. These openings are used to dispose the members in the cover housing 12d. Of the members constituting the electrical connector 12, the back shell 12c is paired with the front shell 12a to form a shell holding the housing 12b. The housing 12b held by the shell supports the plural electrical contacts 121b, which are arranged in three rows, and a contact 122b for grounding. The connector 12, shown in FIG. 5 having the equalizer substrate 14, is one of two plug-type electrical connectors 12 and 13 provided on both ends of the cable. When the plug-type electrical connector 12 is mated to the concave part of a receptacle-type electrical connector provided on the PDP, electrical conduction is produced. The electrical connector 13 on the other side is also a plug-type electrical connector. When the electrical connector 13 is mated to a receptacle-type electrical connector fixed on the tuner, the tuner and the PDP are connected to each other.

In this way, when the tuner and the PDP are connected to each other via the cable assembly and broadcast radio waves transmitted from a broadcast station are received by the tuner, image signals based on broadcast signals are transmitted from the tuner via the cable assembly 10 to the PDP. Since the electrical connector 12 provided on the PDP has the equalizer substrate 14, even in the event of phase jitter in a signal transmitted from the tuner, the phase jitter is removed by the equalizer substrate 14.

Referring to the exploded view of FIG. 5, the following will describe the configuration of the electrical connector 12 having the equalizer substrate 14 while indicating assembling steps.

First, the cable 11 is inserted from the opening 122d provided on the cover housing 12d. The cable 11 has a plurality of wires 111a, 111b, etc., which are tied together while being covered with an outer sheath 11a provided on the outermost periphery of the cable 11. The outer sheath 11a is peeled off to expose the ends of the wires 111a, 111b, etc., and the coatings of the exposed wires 111a, 111b, etc. are also peeled off. When the coatings on the ends of the wires 111a, 111b, etc. are peeled off and conductors in the coatings are exposed, the exposed conductors are soldered on corresponding pads 14a, 14b, etc. on the ends of the equalizer substrate 14, respectively, as shown in FIG. 5.

After the conductors of the wires 11a, 111b, etc. are connected thus to the pads 14a, 14b, etc. of the equalizer substrate 14, the next step is assembling of the housing 12b. The front shell 12a and the back shell 12c of FIG. 5 have through holes 121a and 121c, respectively. The housing 12b is inserted into the through holes 121a and 121c. Flanges 122a and 122c connecting the front shell 12a and the back shell 12c are provided on the rear of the front shell 12a and the front of the back shell 12c, respectively. The flanges 122a and 122c are opposed and connected to each other, so that a shell holding the housing 12b is formed. Clasps 1211a to 1214a are provided on four points of the flange 122a of the front shell 12a. On the flange 121c of the back shell 12c, notches 1211c to 1214c are provided on four points corresponding to the clasps 1211a to 1214a. Therefore, after the housing 12b is inserted into the through holes 121a and 121c, when the flange 121a of the front shell 12a and the flange 121c of the back shell 12c are opposed to each other and the four clasps 1211a to 1214a are mated with the notches 1211c to 1214c on the four points, respectively, the housing 12b is inserted into the shell and held therein.

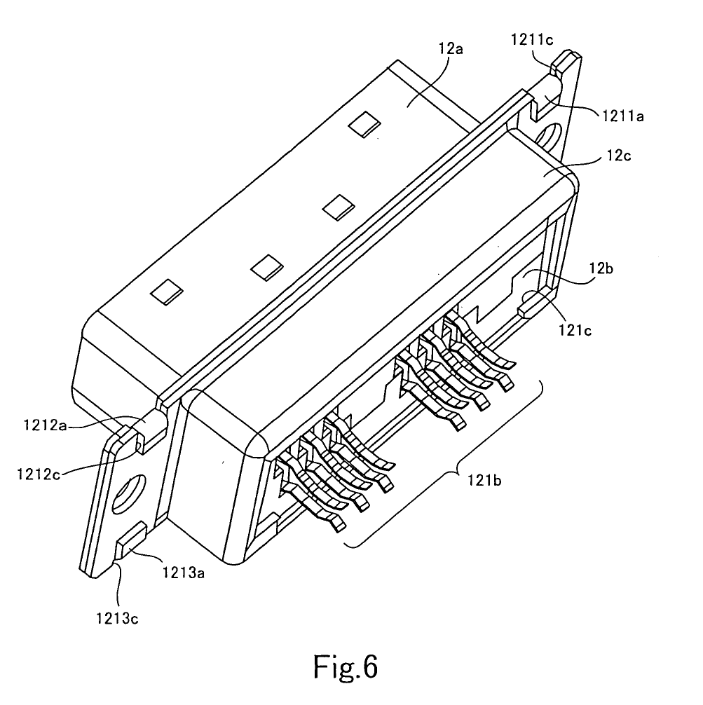

FIG. 6 shows the electrical connector in the assembled state. In FIG. 6 the housing 12b is inserted into the shell and is held by the front shell 12a and the back shell 12c. On the rear of the back shell 12c, electrical contacts 121b are exposed which extend to the rear through the through holes 121d of the back shell 12c. On the side of the front shell 12a, the contacts 121b are disposed in the front shell 12a. The front shell 12a receives a front shell of a mating electrical connector. When a receptacle-type mating electrical connector is mated, the front shells are also mated to each other along with the electrical contacts.

After the shells are assembled, the electrical contacts 121b extending to the rear through the through holes 121c of the back shell 12c are connected to the pads 141a, 141b, etc. of the equalizer substrate 14. Although the electrical connector 13 is configured in a like manner to the connector 12, the size of the cover housing is different due to the absence of an equalizer and the conductors of the wires in the cable are each directly soldered to electrical contacts extending from a back shell.

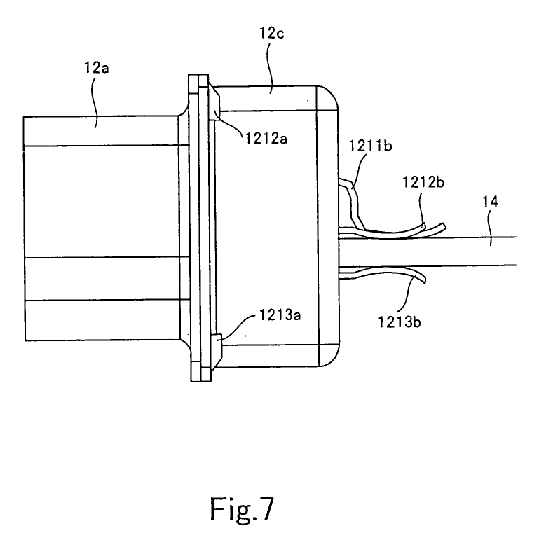

As shown in FIG. 7, an electrical contact 1211b provided uppermost extends over the equalizer substrate 14 and is folded on the side of the equalizer substrate 14 around the pads to which the electrical contacts are connected. The electrical contact 1211b having been folded on the side of the equalizer substrate 14 is further folded along the equalizer substrate 14 on the pads and is disposed on one of the corresponding pads. Electrical contacts 1212b and 1213b other than the uppermost electrical contact 1211b extend substantially along the upper surface and the lower surface of the substrate and are disposed on the corresponding pads. The electrical contacts 1212b and 1213b are soldered on the pads.

The following will briefly describe an operation of an equalizer circuit mounted on the equalizer substrate 14.

Transmission signals transmitted from the tuner via the cable assembly 10 are each inputted to the equalizer circuit mounted on the equalizer substrate 14. The equalizer circuit has passive components such as a capacitor, a resistor, and a coil and reduces phase jitter superimposed on a transmission signal transmitted from the tuner. The transmission signal reduced in phase jitter is transmitted through the pads on the end of the equalizer substrate 14 and the electrical contacts 121b to the PDP. The transmission signal includes an image signal and a clock signal that are required for displaying a moving image. The PDP is fed with an image signal, which has a signal waveform equalized by the equalizer and is improved in quality upon transmission from the tuner, and a clock signal. When the PDP is driven by using the image signal improved in quality, a high-quality image is displayed on the display surface of the PDP.

In the present embodiment, the electrical connectors 12 and 13 of different sizes are fixed on opposite ends of the cable 11 to form the cable assembly 10. Since the size difference can be visually recognized by the user as a visual indicator, it is possible to quickly specify whether the electrical connector should be connected to the PDP or the tuner.

Therefore, the size difference between the electrical connectors is visually recognized by the user as a visual indicator, reducing the possibility of incorrect connection. Further, only the size of the cover housing needs to be changed and additional connector components are unnecessary, reducing the cost.

Considering that the cable assembly 10 is used by an ordinary user at home, it is desirable to further reduce the possibility of incorrect connection with the tuner or the PDP than can be achieved by difference in size of the electrical connectors 12 and 13. Hence, in an exemplary embodiment of the invention, the electrical connectors 12 and 13 fixed on both ends of the cable 10 have the cover housings 12d of different colors to prevent incorrect connection, enhancing the visual indicating effect. In this case, it is effective to have a mating connector housing of the same color. Even an ordinary user always connects one of the electrical connectors of the cable assembly 10 to the PDP or the tuner while viewing the cover housing 12d. Therefore, by providing the cover housings 12d of different colors, which side of the cable is to be connected can be indicated to the ordinary user. In this case, the two cover housings are made of materials of different colors. Alternatively, different colors can be promptly acquired with a simple method of applying a paint on one of the cover housings. Thus, it is possible to provide an inexpensive cable assembly for the user without the necessity for additional components.

The above explanation described the cable assembly compliant with the DVI standard. This example can be readily applied to a cable assembly compliant with the HDMI standard. In this case, as shown in FIG. 3, since the plug-type electrical contacts are arranged in two rows, the electrical contacts and the equalizer substrate can be more readily connected to each other, further reducing the cost.

Besides, the cable assembly of the present invention may be applied to connection between a set top box used for a cable television and a PDP in addition to connection between a PDP and a tuner at home. Further, the cable assembly is also applicable to connection between a liquid crystal projector and the main unit of a personal computer.

As described above, simply by using the size difference of the connectors as a visual indicator, the user can properly connect the tuner and the display. When the cover housings of the electrical connectors fixed on both ends of the cable are provided with different colors, the color difference can be an additional visual indicator. In this case, the colors can be readily changed simply by applying a paint. Therefore, the cover housings of the electrical connectors are made different in size and color, and the shape, size, or color difference of the electrical connectors can be used as a visual indicator. It is not necessary to provide additional components preventing incorrect recognition, reducing the cost of the cable assembly.

Additionally, the equalizer circuit may be an active equalizer circuit as well as a passive equalizer circuit composed of passive components. The equalizer circuit may be directly inserted between the contacts and the cable instead of being formed on the equalizer substrate. In this case, the paired connectors can have the same size and the cover housings of different colors are effective for identifying the connectors.

What is claimed is:

1. An electrical cable assembly, comprising:
a cable, and
electrical connectors which are fixed on both ends of the cable and include an electrical contact and a housing storing the electrical contact, the housings having interchangeable mating surfaces,
wherein only one of the electrical connectors has an equalizer circuit, and at least one of the electrical connectors has a visual indicator different from that of the other electrical connector.

2. The electrical cable assembly according to claim 1, wherein the visual indicator is a color of a cover housing storing the electrical connectors and the equalizer circuit.

3. The electrical cable assembly according to claim 1, wherein the visual indicator is a difference in size with respect to the other connector.

4. The electrical cable assembly according to claim 1, wherein the equalizer circuit comprises a substrate electrically interconnected to the cable and to the connector contact.

5. The electrical cable assembly according to claim 4, wherein the substrate has at least one passive component mounted thereon.

6. The electrical cable assembly according to claim 4, wherein the substrate has at least one active component mounted thereon.

7. The electrical cable assembly according to claim 1, wherein the cable assembly complies with the Digital Visual Interface standard.

8. The electrical cable assembly according to claim 1, wherein the cable assembly complies with the High-Definition Multimedia Inter+face Specification.
